(19) United States
(12) Patent Application Publication
(10) Pub. No.: US 2014/0129337 A1
(43) Pub. Date: May 8, 2014

(54) PROXIMITY-BASED OFFERS FULLY CONTAINED WITHIN AN EMBEDDED AD UNIT

(71) Applicant: Beintoo, S.p.A., Milan (IT)

(72) Inventors: Lon E. OTREMBA, Douglaston, NY (US); Paul Frank MUNSCH, Stamford, CT (US); Daniele B. MARTINELLI, Airmont, NY (US); Corey Anthony JEFFERS, Brooklyn, NY (US)

(73) Assignee: Beintoo, S.p.A., Milan (IT)

(21) Appl. No.: 14/066,573

(22) Filed: Oct. 29, 2013

Related U.S. Application Data
(60) Provisional application No. 61/722,687, filed on Nov. 5, 2012.
(60) Provisional application No. 61/739,188, filed on Dec. 19, 2012.

(51) Int. Cl. G06Q 30/02

(52) U.S. Cl. CPC G06Q 30/0261; G06Q 30/0267
USPC 705/14.58

(57) ABSTRACT

Computer systems, storage media encoded with software, and methods comprising a first processing device configured to generate and deliver an ad unit for at least one good or service offered at a physical retail outlet, the ad unit delivered to an application executing on a second processing device, the ad unit providing: a display of one or more outlets, the outlets offering the at least one good or service, the outlets located within a first threshold distance from the second processing device; directions from the location of the second processing device to a selected outlet; and at least one proximity-based offer, the offer triggered by presence of the second processing device within a second threshold distance from the selected outlet; provided that the display of one or more outlets, the directions, and the at least one proximity based-offer are provided within the application executing on the second processing device.

### CROSS-REFERENCE TO RELATED APPLICATIONS

This application claims the benefit of U.S. Application Ser. No. 61/722,687, filed Nov. 5, 2012 and U.S. Application Ser. No. 61/739,188, filed Dec. 19, 2012, each of which is hereby incorporated by reference in its entirety.

### BACKGROUND OF THE INVENTION

According to IAB research, the mobile advertising market tripled in volume in 2011 ($1.6 billion in revenue) in comparison with 2010 ($600 million). eMarketer estimates that this trend will continue in 2012 and that U.S. mobile advertising spending will grow 80% to $2.61 billion.

eMarketer estimates U.S. mobile display ad spending, which includes spending on banner and rich media ads, will grow 93.5% to $861.7 million in 2012, after reaching $445.4 million in 2011. Mobile display ads are currently estimated to represent 33% of the U.S. mobile ad market and are this share is expected to grow in each of the next several years.

### SUMMARY OF THE INVENTION

Despite rapid growth, however, mobile advertising accounted for less than 1% of total ad spending in the U.S. in 2011, according to eMarketer. A persistent problem is mobile application providers are currently unable to successfully implement monetization strategies for mobile users though advertising. Current embedded mobile ad units are disruptive to user experience because they merely link to mobile web pages, open another installed application, or provide links to download and install additional apps. Information and benefits are not provided within the ad unit. Moreover, existing mobile ad units do not adequately leverage geolocation technologies to provide users with relevant and timely information and benefits.

In contrast, the systems, software, and methods described herein provide an ad unit, which is expandable to provide location-based information and benefits fully contained within the ad unit. Advantages of the systems, software, and methods described herein include, but are not limited to, more engaging and effective mobile advertizing, direct monetization of mobile ad units, and provision of more relevant, location-based information and benefits.

In one aspect, disclosed herein are computer-implemented systems comprising a first processing device configured to generate and deliver an ad unit for at least one good or service offered at a physical retail outlet, the ad unit delivered to an application executing on a second processing device, the ad unit providing, in response to a user interaction: a display of one or more physical retail outlets, the outlets offering the at least one good or service, the outlets located within a first threshold distance from the second processing device; directions from the location of the second processing device to a selected physical retail outlet; and at least one proximity-based offer, the offer triggered by presence of the second processing device within a second threshold distance from the selected physical retail outlet; provided that the display of one or more physical retail outlets, the directions, and the at least one proximity based-offer are provided within the application executing on the second processing device. In some embodiments, the second processing device is a mobile device. In some embodiments, the physical retail outlets are displayed on a map. In some embodiments, the physical retail outlets are displayed as a list, the list ranked by distance to the user location. In some embodiments, the first threshold distance is less than about 10 miles, less than about 5 miles, less than about 2 miles, or less than about 1 mile. In further embodiments, the first threshold distance is less than about 1000 meters, less than about 500 meters, less than about 200 meters, or less than about 100 meters. In some embodiments, the second threshold distance is less than about 5 miles, less than about 2 miles, less than about 1 mile, or less than about 0.5 miles. In further embodiments, the second threshold distance is less than about 500 meters, less than about 200 meters, less than about 100 meters, or less than about 50 meters. In some embodiments, the directions are walking directions, cycling directions, or driving directions. In some embodiments, the offer comprises a discount, coupon, or voucher. In some embodiments, the application executing on the second processing device is a web browser, a mobile web browser, or a native mobile application. In some embodiments, the ad unit is an expanding banner ad, an interstitial ad, a three-dimensional multimedia ad, or a combination thereof. In some embodiments, the user interaction is made via a touchscreen and is selected from: touch, tap, swipe, double tap, reverse pinch, and shake. In some embodiments, the user interaction is made via a pointing device and is selected from: hover, click, drag, double click, and highlight. In other embodiments, the user interaction is made via a microphone and is a voice command. In yet other embodiments, the user interaction is made via a camera and is a gesture. In some embodiments, the offer comprises a request for information. In further embodiments, the request for information is a registration process. In some embodiments, the proximity-based offer does not require user check-in. In some embodiments, the ad unit does not open a browser window and does not open a mobile application.

In another aspect, disclosed herein are computer-implemented methods comprising the steps of: generating, by a first processing device, an ad unit for at least one good or service offered at a physical retail outlet; and delivering, by the first processing device, the ad unit to an application executing on a second processing device, the ad unit providing: a display of one or more physical retail outlets, the outlets offering the at least one good or service, the outlets located within a first threshold distance from the second processing device; directions from the location of the second processing device to a selected physical retail outlet; and at least one proximity-based offer, the offer triggered by presence of the second processing device within a second threshold distance from the selected physical retail outlet; with the proviso that that the display of one or more physical retail outlets, the directions, and the at least one proximity based-offer are provided within the application executing on the second processing device. In some embodiments, the second processing device is a mobile device. In some embodiments, the physical retail outlets are displayed on a map. In some embodiments, the physical retail outlets are displayed as a list, the list ranked by distance to the user location. In some embodiments, the first threshold distance is less than about 10 miles, less than about 5 miles, less than about 2 miles, or less than about 1 mile. In further embodiments, the first threshold distance is less than about 1000 meters, less than about 500 meters, less than about 200 meters, or less than about 100 meters. In some embodiments, the second threshold distance is less than about 5 miles, less than about 2 miles, less than about 1 mile, or less than about 0.5 mile. In further embodiments, the second threshold distance is less than about 500 meters, less than about 200 meters, less than about 100 meters, or less than about 50 meters. In some embodiments, the directions are walking directions, cycling directions, or driving directions. In some embodiments, the offer comprises a discount, coupon, or voucher. In some embodiments, the application executing on the second processing device is a web browser, a mobile web browser, or a native mobile application. In some embodiments, the ad unit is an expanding banner ad, an interstitial ad, a three-dimensional multimedia ad, or a combination thereof. In some embodiments, the user interaction is made via a touchscreen and is selected from: touch, tap, swipe, double tap, reverse pinch, and shake. In some embodiments, the user interaction is made via a pointing device and is selected from: hover, click, drag, double click, and highlight. In other embodiments, the user interaction is made via a microphone and is a voice command. In yet other embodiments, the user interaction is made via a camera and is a gesture. In some embodiments, the offer comprises a request for information. In further embodiments, the request for information is a registration process. In some embodiments, the proximity-based offer does not require user check-in. In some embodiments, the ad unit does not open a browser window and does not open a mobile application.

In another aspect, disclosed herein are non-transitory computer-readable storage media encoded with a computer program including instructions executable by a processor to create and deliver a mobile ad unit comprising: a software module configured to determine the location of a mobile user; a software module configured to display of one or more physical retail outlets, the outlets offering at least one good or service, the outlets located within a first threshold distance from the user; a software module configured to provide directions from the location of the user to a selected physical retail outlet; and a software module configured to provide at least one proximity-based offer, the offer triggered by presence of the user within a second threshold distance from the selected physical retail outlet; provided that the display of one or more physical retail outlets, the directions, and the at least one proximity based-offer are fully contained within the ad unit. In some embodiments, the ad unit is delivered to a web browser, a mobile web browser, or a native mobile application. In some embodiments, the ad unit is an expanding banner ad, an interstitial ad, a three-dimensional multimedia ad, or a combination thereof. In some embodiments, the physical retail outlets are displayed on a map. In some embodiments, the physical retail outlets are displayed as a list, the list ranked by distance to the user location. In some embodiments, the first threshold distance is less than about 10 miles, less than about 5 miles, less than about 2 miles, or less than about 1 mile. In further embodiments, the first threshold distance is less than about 1000 meters, less than about 500 meters, less than about 200 meters, or less than about 100 meters. In some embodiments, the second threshold distance is less than about 5 miles, less than about 2 miles, less than about 1 mile, or less than about 0.5 mile. In further embodiments, the second threshold distance is less than about 500 meters, less than about 200 meters, less than about 100 meters, or less than about 50 meters. In some embodiments, the directions are walking directions, cycling directions, or driving directions. In some embodiments, the offer comprises a discount, coupon, or voucher. In some embodiments, the user interaction is made via a mobile device touchscreen and is selected from: touch, tap, swipe, double tap, reverse pinch, and shake. In some embodiments, the user interaction is made via a mobile pointing device and is selected from: hover, click, drag, double click, and highlight. In other embodiments, the user interaction is made via a mobile device microphone and is a voice command. In yet other embodiments, the user interaction is made via a mobile device camera and is a gesture. In some embodiments, the offer comprises a request for information. In further embodiments, the request for information is a registration process. In some embodiments, the proximity-based offer does not require user check-in. In some embodiments, the ad unit does not open a browser window and does not open a mobile application.

### BRIEF DESCRIPTION OF THE DRAWINGS

FIG. 1 shows a non-limiting example of an ad unit; in this case, an ad unit embedded in a mobile application environment. In this embodiment, the ad unit is interactive and expands to provide physical retail outlet information.

FIG. 2 shows a non-limiting example of a display of physical retail outlets within an ad unit; in this case, a display of retailers on a map that demonstrates proximity of physical retail outlet to a mobile application user.

FIG. 3 shows a non-limiting example of a GUI for displaying a selected physical retail outlet within an ad unit; in this case, a GUI providing a phone number, address and directions to and from the selected physical retail outlet.

FIG. 4 shows a non-limiting example of a GUI for displaying directions to a selected physical retail outlet within an ad unit; in this case, a GUI providing turn-by-turn walking directions.

FIG. 5 shows a non-limiting example of a proximity-based offer; in this case, an offer for a product offered by a physical retail outlet and including a request for user information.

FIG. 6 shows another non-limiting example of a GUI for displaying directions to a selected physical retail outlet within an ad unit; in this case, a GUI providing turn-by-turn directions adapted for driving. In this example, the directions are optionally adapted for public transit or bicycling in addition to driving.

FIG. 7 shows another non-limiting example of a GUI for displaying directions to a selected physical retail outlet within an ad unit; in this case, a GUI providing turn-by-turn directions adapted for walking. In this example, the directions are optionally adapted for public transit or bicycling in addition to driving.

FIG. 8 shows another non-limiting example of a proximity-based offer; in this case, an offer for a product offered by a physical retail outlet and including a date and time of expiration.

FIG. 9 shows a first exemplary entry point to an ad unit described herein.

FIG. 10 shows a second exemplary entry point to an ad unit described herein; in this case, an in-game reward entry point.

FIG. 11 shows a third exemplary entry point to an ad unit described herein; in this case, an ad-unit banner entry point.

FIG. 12 shows a non-limiting exemplary landing page; in this case, a landing page presented when a user interacts with an element of an entry point.

FIG. 13 shows a non-limiting exemplary email sent page; in this case, an email sent page presented when a user enters their email in the “remind me later” section of the landing page depicted in FIG. 12.

FIG. 14 shows a non-limiting exemplary geolocation permission dialog.

FIG. 15 shows a non-limiting exemplary instruction page; in this case, an instruction page presented if a user clicks on “don't allow” button on the dialog depicted in FIG. 14, the instruction page is shown in order to allow the user to alternatively obtain instructions via email.

FIG. 16 shows a non-limiting exemplary directions page; in this case, a directions page providing a map and directions to a physical retail outlet offering a good or service which is the subject matter of the as unit, the physical retail outlet located within a threshold distance from the user.

FIG. 17 shows the directions page depicted in FIG. 16 including options for the user to switch between walking directions and driving directions.

FIG. 18 shows a non-limiting exemplary instruction page; in this case, an instruction page presented if a user clicks on “know the way?” button on the page depicted in FIGS. 16 and 17, the instruction page is shown in order to allow the user to alternatively obtain instructions via email.

FIG. 19 shows a non-limiting exemplary arrival overlay; in this case, an arrival overlay presented over a directions page when a user is within a threshold distance from a physical retail outlet offering a good or service which is the subject matter of the as unit.

FIG. 20 shows a non-limiting exemplary proximity-based offer; in this case, a proximity-based offer in the form of a coupon.

FIG. 21 shows a non-limiting exemplary “remind me later” email; in this case, an email allowing a user to redeem their offer to the physical retail outlet anytime.

FIG. 22 shows a non-limiting exemplary follow-up “remind me later” email; in this case, an email sent 3 days after the email depicted in FIG. 21.

FIG. 23 shows a non-limiting exemplary proximity-based offer email; in this case, an email sent to the user when they access their offer.

### DETAILED DESCRIPTION OF THE INVENTION

Current mobile ad units are disruptive to the mobile user experience and fail to adequately monetize mobile user experiences though advertising. Importantly, existing mobile ad units do not adequately utilize real-time location information to provide benefits that are tuned to the situation of each user.

Accordingly, described herein, in certain embodiments, are computer-implemented systems comprising a first processing device configured to generate and deliver an ad unit for at least one good or service offered at a physical retail outlet, the ad unit delivered to an application executing on a second processing device, the ad unit providing, in response to a user interaction: a display of one or more physical retail outlets, the outlets offering the at least one good or service, the outlets located within a first threshold distance from the second processing device; directions from the location of the second processing device to a selected physical retail outlet; and at least one proximity-based offer, the offer triggered by presence of the second processing device within a second threshold distance from the selected physical retail outlet; provided that the display of one or more physical retail outlets, the directions, and the at least one proximity based-offer are provided within the application executing on the second processing device.

Also described herein, in certain embodiments, are computer-implemented methods comprising the steps of: generating, by a first processing device, an ad unit for at least one good or service offered at a physical retail outlet; and delivering, by the first processing device, the ad unit to an application executing on a second processing device, the ad unit providing: a display of one or more physical retail outlets, the outlets offering the at least one good or service, the outlets located within a first threshold distance from the second processing device; directions from the location of the second processing device to a selected physical retail outlet; and at least one proximity-based offer, the offer triggered by presence of the second processing device within a second threshold distance from the selected physical retail outlet; with the proviso that that the display of one or more physical retail outlets, the directions, and the at least one proximity based-offer are provided within the application executing on the second processing device.

Also described herein, in certain embodiments, are non-transitory computer-readable storage media encoded with a computer program including instructions executable by a processor to create and deliver a mobile ad unit comprising: a software module configured to determine the location of a mobile user; a software module configured to display of one or more physical retail outlets, the outlets offering at least one good or service, the outlets located within a first threshold distance from the user; a software module configured to provide directions from the location of the user to a selected physical retail outlet; and a software module configured to provide at least one proximity-based offer, the offer triggered by presence of the user within a second threshold distance from the selected physical retail outlet; provided that the display of one or more physical retail outlets, the directions, and the at least one proximity based-offer are fully contained within the ad unit.

### CERTAIN DEFINITIONS

Unless otherwise defined, all technical terms used herein have the same meaning as commonly understood by one of ordinary skill in the art to which this invention belongs. As used in this specification and the appended claims, the singular forms “a,” “an,” and “the” include plural references unless the context clearly dictates otherwise. Any reference to “or” herein is intended to encompass “and/or” unless otherwise stated.

### Ad Unit

In some embodiments, the systems, software, and methods described herein include an ad unit for at least one good or service offered at a physical retail outlet, or use of the same. In further embodiments, the systems, software, and methods described herein include a processing device configured to generate an ad unit for at least one good or service offered at a physical retail outlet, or use of the same. In still further embodiments, the ad unit is delivered to an application executing on a processing device. In some embodiments, the ad unit for at least one good or service is delivered to an application executing on a distinct processing device. In further embodiments, the ad unit for at least one good or service is delivered to a plurality of distinct processing devices (e.g., a network of processing devices). In still further embodiments, the ad unit is delivered to an application executing on a mobile processing device or a plurality of mobile processing devices (e.g., a network of mobile processing devices).

In some embodiments, the ad unit is a mobile ad unit. In further embodiments, the ad unit is a mobile embeddable ad unit. In still further embodiments, the ad unit is an expanding banner ad, an interstitial ad, a multimedia interactive ad, a three-dimensional multimedia ad, or a combination thereof. In some embodiments, the ad unit is embedded in an online property or a mobile application. Any type of web site, mobile web site, or mobile application is suitable.

In some embodiments, the ad unit is for at least one good or service. In further embodiments, the at least one good or service is offered for sale at a physical retail outlet. Many goods are suitable for advertizing via the ad units described herein. In further embodiments, suitable goods include consumer goods such as convenience goods, specialty goods, shopping goods, luxury goods, durable goods, semi-durable goods, and non-durable goods. By way of various non-limiting examples, suitable goods include food, beverages, clothing, shoes, fashion accessories, jewelry, fragrances, entertainment media, personal care items, cosmetics, home goods, furniture, appliances, vehicles, exercise equipment, and the like. Many services are suitable for advertizing via the ad units described herein. By way of various non-limiting examples, suitable services include hospitality services, beauty services, transportation services, communication services, spa services, construction services, and the like.

In some embodiments, the ad unit advertizes one good or service. In other embodiments, the ad unit advertizes a plurality of goods and/or services. In various embodiments, the ad unit advertizes 1, 2, 3, 4, 5, 6, 7, 8, 9, 10, 11, 12, 13, 14, 15, 16, 17, 18, 19, 20 or more goods and/or services. In further embodiments, the ad unit advertizes a group of related goods and/or services.

In some embodiments, an ad unit is expandable. In further embodiments, an ad unit is expandable to provide a display of one or more physical retail outlets, directions to a selected physical retail outlet, and/or at least one proximity-based offer. In some embodiments, an ad unit is expandable in response to a user interaction described further herein. In various embodiments, an ad unit is expandable to occupy about 20, 25, 30, 35, 40, 45, 50, 55, 60, 65, 70, 75, 80, 85, 90, 91, 92, 93, 94, 95, 96, 97, 98, or 99 percent of the available area of a mobile display, including increments therein. In various embodiments, an ad unit is expandable to occupy at least about 20, 25, 30, 35, 40, 45, 50, 55, 60, 65, 70, 75, 80, 85, 90, 91, 92, 93, 94, 95, 96, 97, 98, or 99 percent of the available area of a mobile display, including increments therein. In a particular embodiment, an ad unit is expandable to occupy all of the available area of a mobile display.

In some embodiments, the display of one or more physical retail outlets, directions to a selected physical retail outlet, and proximity-based offers are provided entirely within the application executing on a processing device. In further embodiments, an ad unit provides a display of one or more physical retail outlets, directions to a selected physical retail outlet, and at least one proximity-based offer without linking to mobile web pages, opening another installed application, or providing links to download and install additional apps. In still further embodiments, a display of one or more physical retail outlets, directions to a selected physical retail outlet and at least one proximity-based offer are completely contained within a mobile ad unit.

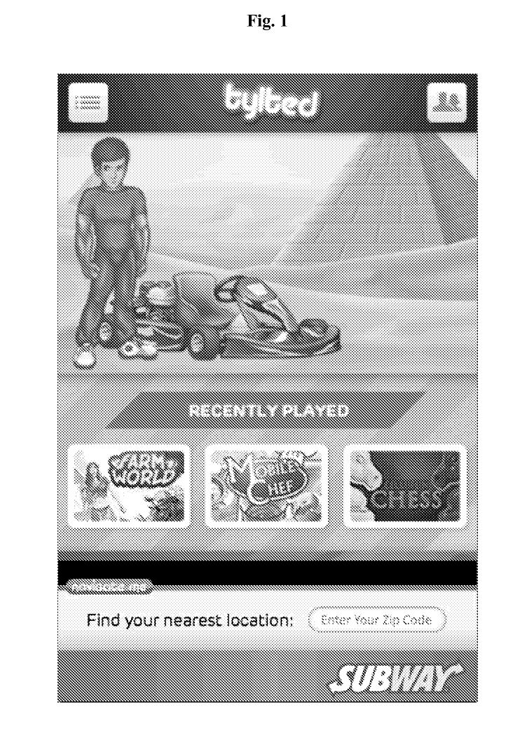

Referring to FIG. 1, in a particular embodiment, a mobile ad unit is embedded in a mobile application for playing games. In this embodiment, the ad unit is an expandable banner ad that expands in response to a user interaction (e.g., touch, tap, etc.) to provide the features and benefits described herein. Further in this embodiment, the ad unit identifies a retailer and requests location information from a user.

### Physical Retail Outlets

In some embodiments, the systems, software, and methods described herein include a display of one or more physical retail outlets. As used herein, in some embodiments, a “physical retail outlet” is a commercial establishment offering at least one good or service with at least one physical facility adapted for consumers. In further embodiments, the one or more physical retail outlets are located within a threshold distance from a user of the systems, software, and methods described herein or a device associated with a user. In further embodiments, the systems, software, and methods described herein include directions to a selected physical retail outlet. In still further embodiments, the systems, software, and methods described herein include a proximity-based offer from a physical retail outlet.

In some embodiments, the systems, software, and methods described herein include a display of one or more physical retail outlets offering a good or service that is the subject of an ad unit described herein. In some embodiments, a physical retail outlet is the sole source of a good or service. In other embodiments, a physical retail outlet merely one source of a good or service. In some embodiments, a physical retail outlet sells only the good or service that is the subject of the ad unit. In other embodiments, a physical retail outlet sells a plurality of goods and/or services, of which the subject of the ad unit is one. In some embodiments, the systems, software, and methods described herein include a display of one or more physical retail outlets that are within a threshold distance from a user of the systems, software, and methods described herein or a device associated with a user. In various embodiments, the physical retail outlet is, for example, a department store, a restaurant, a bar, a lounge, a clothing store, a shoe store, a fashion accessory store, a jewelry store, an appliance store, a furniture store, a music store, a movie theater, a hotel, a motel, a resort, a spa, a salon, or the like.

### Geolocation

In some embodiments, the systems, software, and methods described herein include a display of one or more physical retail outlets located within a threshold distance from a user or a processing device associated with a user. In further embodiments, the systems, software, and methods described herein include directions from a user's location or that of a processing device associated with the user to a selected physical retail outlet. In still further embodiments, the systems, software, and methods described herein include a proximity-based offer from a physical retail outlet, wherein the offer is triggered by proximity of a user or a processing device associated with the user to the physical retail outlet. In some embodiments, the software module for displaying a map or list of physical retail outlets, presenting directions to a physical retail outlet, or displaying proximity-based offer requests location information from a mobile processing device. In various embodiments, a mobile processing device is in the possession of a user. In some embodiments, a mobile processing device identifies location by geolocation via one or more geolocation services.

Geolocation is the identification of the real-world geographic location of an object, such as a computer, mobile smartphone, or a portable computing device such as a laptop or tablet computer. A location is suitably expressed in a number of ways including, by way of non-limiting examples, geographic coordinates (e.g., latitude and longitude), a place name (e.g., county, city, landmark, intersection, etc.), a physical street address, distance from a given location, presence within a specified radius from a given location, and a graphical depiction on a map. In some cases, geolocation involves geocoding to find associated latitude and longitude from other geographic data. In some cases, geolocation involves reverse geocoding to back code latitude and longitude coordinates to a readable address or place name.

Many methods of geolocation are suitable that utilize several underlying sources of location information. In some embodiments, a software module geolocates, for example, a consumer, a mobile processing device, a retail item, or a physical retail outlet using sources of location information including, by way of non-limiting examples, GPS coordinates provided by a processing device, triangulation between mobile phone towers and public masts (e.g., assistive GPS), Wi-Fi connection location, WHOIS performed on IP address or MAC address (e.g., WiFi base station MAC address), GSM/CDMA cell IDs (e.g., identification, triangulation, and multilateration), and location information self-reported by a user. In some embodiments, location information includes position (e.g., latitude and longitude), elevation, heading, speed, orientation, and combinations thereof.

In some embodiments, a software module geolocates, for example, a consumer, a mobile processing device, or a physical retail outlet by using the HTML 5 geolocation API. In light of the disclosure provided herein, those of skill in the art will recognize that the HTML 5 geolocation API is supported in Internet Explorer 9.0+, Firefox 3.5+, Safari 5.0+, Chrome 5.0+, Opera 10.6+, iOS 3.0+, Android 2.0+, and Windows Phone 7.5+. In some embodiments, a software module geolocates, for example, a news event or a contributor using methods aligned with W3C Geolocation API (available at: http://dev.w3.org/geo/api/spec-source.html). The W3C Geolocation API defines an interface to location information associated with a processing device (e.g., smartphone, tablet computer, laptop computer, etc.) hosting the implementation, such as latitude and longitude.

In some embodiments, the platforms, systems, software, applications, and methods disclosed herein perform geolocation by one method, such as those disclosed herein. In other embodiments, the platforms, systems, software, applications, and methods disclosed herein perform geolocation by more than one method.

In some embodiments, the geolocation of, for example, a user, a mobile processing device, a or a physical retail outlet is accurate to within at least 100, 90, 80, 70, 60, 50, 40, 30, 20, 10, 9, 8, 7, 6, 5, 4, 3, 2, 1 or fewer kilometers, including increments therein. In further embodiments, the geolocation is accurate to within at least 1000, 900, 800, 700, 600, 500, 400, 300, 200, 100, 90, 80, 70, 60, 50, 40, 30, 20, 10, 9, 8, 7, 6, 5, 4, 3, 2, 1 or fewer meters, including increments therein.

In some embodiments, location information is stored in a database of location information. In further embodiments, the systems, software, applications, and methods described herein include a database of location information for physical retail outlets and proximity-based offers. In still further embodiments, a database of location information includes location information for physical retail outlets participating in a proximity-based offer program. In some embodiments, the systems, software, applications, and methods described herein include a database of location information for users of the mobile devices and mobile applications described herein. In further embodiments, the location information is updated in a database upon a user's interaction with a mobile ad unit. In other embodiments, the location information is updated in a database, for example, once a day, once an hour, once a minute, or once a second, including increments therein. In still further embodiments, the location information is updated in a database on a continuous or substantially continuous basis to provide real-time or substantially real-time location information. In some cases continuously updated location information is necessary to provide effective turn-by-turn directions to a user.

In some embodiments, the systems, software, applications, and methods described herein include a software module for determining if a user is within a threshold distance of a physical retail outlet. Accordingly, in some embodiments, the systems, software, applications, and methods described herein include a software module for determining the distance between a specified location and one or more physical retail outlets, such as those of a retailer participating in a proximity-based offer program. In further embodiments, a software module for determining the distance between a specified location and one or more physical retail outlets identifies outlets within a specified radius from a specified location.

### Map and Directions

In some embodiments, the systems, software, and methods described herein include a display of one or more physical retail outlets. In further embodiments, physical retail outlets are identified as offering a good or service that is the subject of an ad unit described herein. In further embodiments, the one or more physical retail outlets are located within a threshold distance from a user of the systems, software, and methods described herein or a device associated with a user.

Many threshold distances are suitable. In various embodiments, a display of physical retail outlets includes those located within about 100, 90, 80, 70, 60, 50, 40, 30, 20, 15, 10, 9, 8, 7, 6, 5, 4, 3, 2, or 1 miles of a user of the systems, software, and methods described herein or a device associated with a user, including increments therein. In various embodiments, a display of physical retail outlets includes those located within about 5000, 4000, 3000, 2000, 1000, 900, 800, 700, 600, 500, 400, 300, 200, 100, 90, 80, 70, 60, 50, 40, 30, 20, or 10 meters of a user of the systems, software, and methods described herein or a device associated with a user, including increments therein. In some embodiments, a display of physical retail outlets includes those located in an area defined by a circle with a radius of the threshold distance about the user's location. In other embodiments, a display of physical retail outlets includes those located along a driving, cycling, or walking path shorter than the threshold distance. In some embodiments, the threshold distance is configured by the user. In other embodiments, the threshold distance is configured by the retailer. In yet other embodiments, the threshold distance is configured by a developer of the systems, software, and methods described herein. In some embodiments, the threshold distance is fixed. In other embodiments, the threshold distance is variable. In further embodiments, the threshold distance varies based on the type of goods and/or services, the user's location (e.g. urban, suburban, rural, etc.), and the like.

A display of physical retail outlets suitably includes a wide range of numbers of physical retail outlets based on their offerings and distance from the user or a device associated with the user. In various embodiments, display of physical retail outlets includes 0, 1, 2, 3, 4, 5, 6, 7, 8, 9, 10, 11, 12, 13, 14, 15, 16, 17, 18, 19, 20, 25, 30, 35, 40, 45, 50, 55, 60, 65, 70, 75, 80, 85, 90, 95, 100, 150, 200, 250, 300, 350, 400, 450, 500 or more physical retail outlets, including increments therein.

In some embodiments, a display of physical retail outlets is presented as a map. In further embodiments, a map includes a point indicating the location of the user or a device associated with the user and one or more physical retail outlets offering at least one of the goods or services advertised in the ad unit and within the threshold distance of the user (or their device). In some embodiments, each indicator for a physical retail outlet is interactive and optionally provides details on the particular physical retail outlet indicated as well as allows selection of a particular outlet. In further embodiments, a map is scalable (e.g., capable of being zoomed in and out) and scrollable (e.g., capable of being panned in any direction).

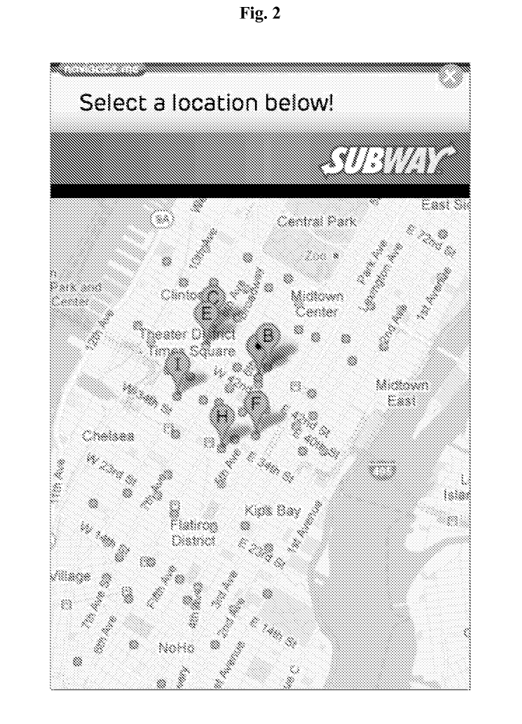

Referring to FIG. 2, in a particular embodiment, an ad unit advertising a food product is expanded in response to a user interaction to provide a map of physical retail outlet offering the food product for sale. In this embodiment, the user's position is indicated as well as location of six physical retail outlets within the threshold distance. Further in this embodiment, each physical retail outlet indicator is interactive and optionally provides more detailed information about the physical retail outlet indicated (e.g., hours, phone number, address, etc.) and allows selection of a particular outlet.

In some embodiments, a display of physical retail outlets is presented as a list. In further embodiments, a list is sorted based on various parameters. In still further embodiments, a list of physical retail outlets is sorted based on, by way of non-limiting examples, distance, rating, price, previous visits, user preferences, and the like.

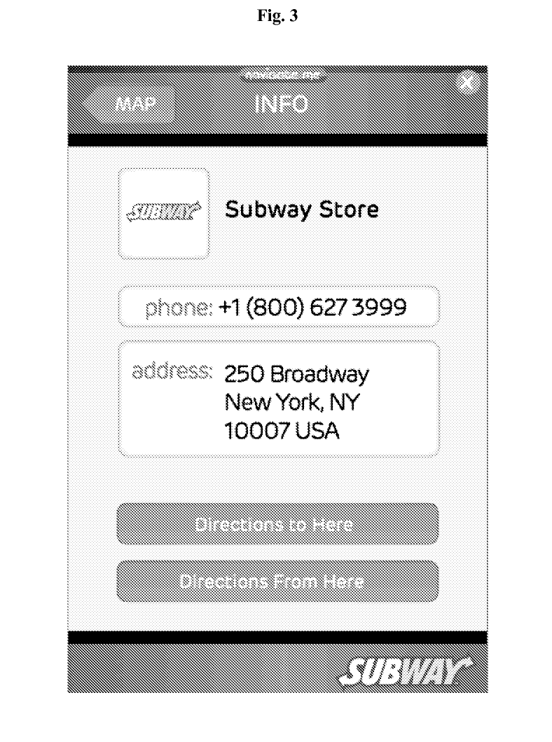

Referring to FIG. 3, in a particular embodiment, a user interacts with an indicator for a particular physical retail outlet offering the advertised good or services within the threshold distance. In this embodiment, detailed information is provided on the selected physical retail outlet including name, phone number, and address. Further, in this embodiment, the user is presented with options to obtain directions to and/or from the selected physical retail outlet.

In further embodiments, the systems, software, and methods described herein include directions to and/or from a selected physical retail outlet. In further embodiments, the directions are provided on a map. In some embodiments, the directions are turn-by-turn navigation directions and include animated and/or voice audio directions. In further embodiments, a user optionally configures the characteristics of voice audio directions including, by way of non-limiting examples, gender, pitch, speed, accent, and volume.

Many types of directions are suitable. In various embodiments, directions are provided that are suitable for driving, cycling, walking, and or using mass transit (e.g., public transit). In further embodiments, mass transit directions comprise stations, routes, and schedules for one or more of: subway systems, rail systems (e.g., train, tram, light rail, etc.), buses, trolleys, streetcars, ferries, and the like. In some embodiments, the type of directions provided are configurable by a user, by a retailer, or by a developer of the systems, software, and methods described herein.

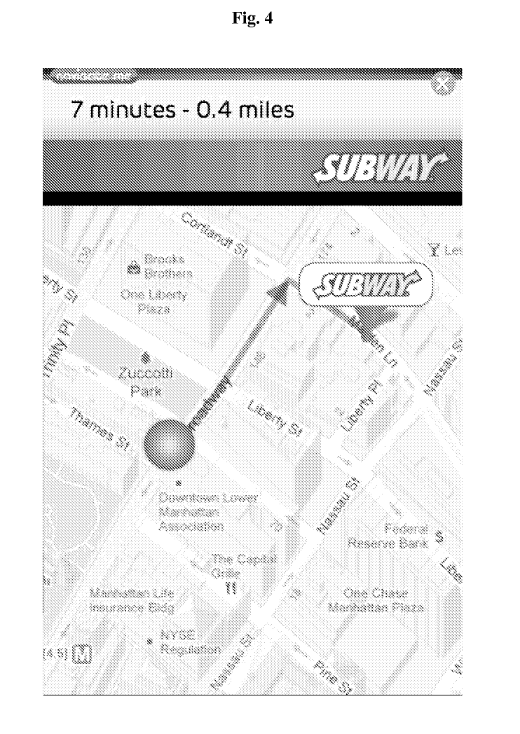

Referring to FIG. 4, in a particular embodiment, a user selects a particular physical retail outlet offering the advertised good or services within the threshold distance. In this embodiment, the user is provided with directions from the user's location to the outlet.

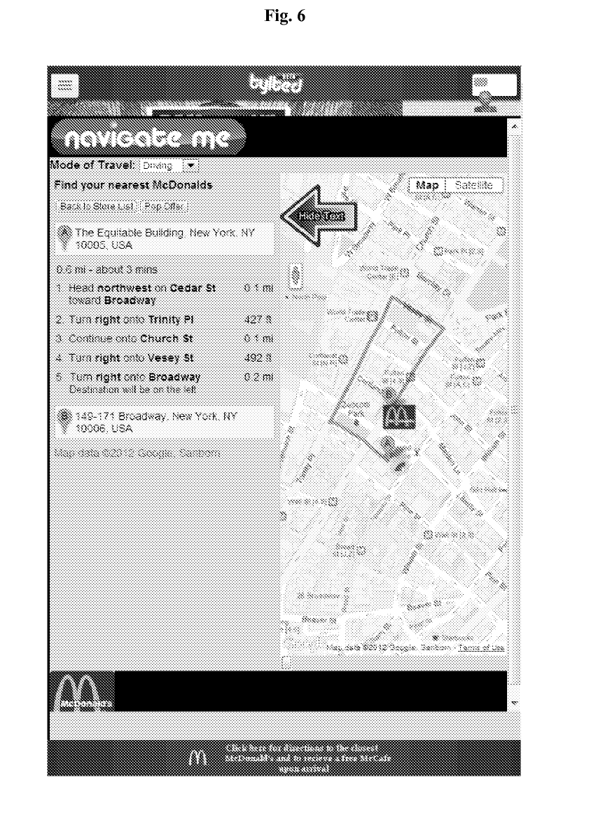

Referring to FIG. 6, in a particular embodiment, a user selects a particular physical retail outlet offering the advertised good or services within the threshold distance. In this embodiment, the user is provided with turn-by-turn driving directions from the user's location to the outlet.

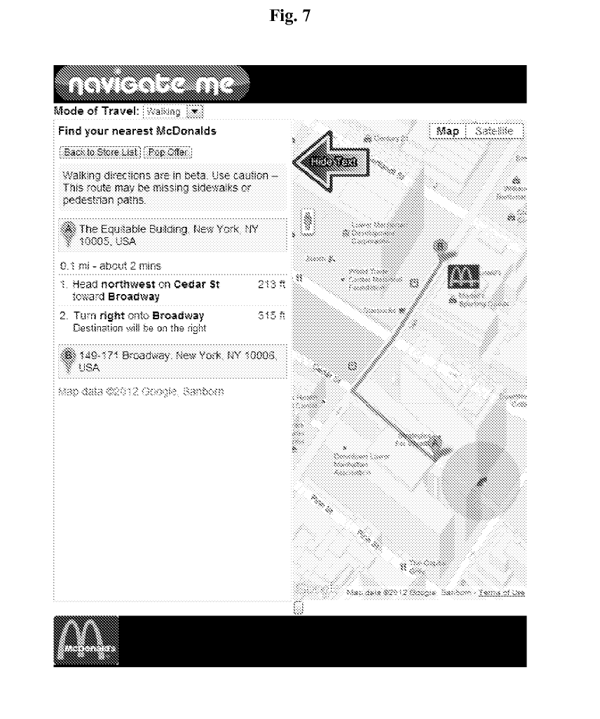

Referring to FIG. 7, in a particular embodiment, a user selects a particular physical retail outlet offering the advertised good or services within the threshold distance. In this embodiment, the user is provided with turn-by-turn walking directions from the user's location to the outlet.

### Proximity-Based Offer

In some embodiments, the systems, software, and methods described herein include one or more proximity based offers. In further embodiments, a proximity-based offer is triggered by presence of a user or a device associated with the user within a threshold distance from the selected physical retail outlet.

Many threshold distances are suitable. In various embodiments, a proximity-based offer is triggered by presence of a user or a device associated with the user within about 100, 90, 80, 70, 60, 50, 40, 30, 20, 15, 10, 9, 8, 7, 6, 5, 4, 3, 2, or 1 miles of a selected physical retail outlet, including increments therein. In various embodiments, a proximity-based offer is triggered by presence of a user or a device associated with the user within about 5000, 4000, 3000, 2000, 1000, 900, 800, 700, 600, 500, 400, 300, 200, 100, 90, 80, 70, 60, 50, 40, 30, 20, or 10 meters of a selected physical retail outlet, including increments therein. In some embodiments, a proximity-based offer is made by a retailer located in an area defined by a circle with a radius of the threshold distance about the user's location. In other embodiments, a proximity-based offer is made by a retailer located along a driving, cycling, or walking path shorter than the threshold distance. In some embodiments, the threshold distance is configured by the user. In other embodiments, the threshold distance is configured by the retailer. In yet other embodiments, the threshold distance is configured by a developer of the systems, software, and methods described herein. In some embodiments, the threshold distance is fixed. In other embodiments, the threshold distance is variable. In further embodiments, the threshold distance varies based on the type of goods and/or services, the user's location (e.g. urban, suburban, rural, etc.), and the like.

Many types of offers are suitable. In various embodiments, a proximity-based offer comprises a discount, coupon, voucher, gift card, or a combination thereof. In various embodiments, a proximity-based offer includes a 1, 5, 10, 15, 20, 25, 30, 35, 40, 45, 50, 55, 60, 65, 70, 75, 80, 85, 90, 95, or 100% discount, including increments therein, for an advertised good or service. In some embodiments, a proximity-based offer includes voucher for a free advertised good or service. In some embodiments, a proximity-based offer includes a specific offer for an advertised good or service including, by way of non-limiting examples, buy one get one free, buy two get one free, buy one get another at a discount, and the like.

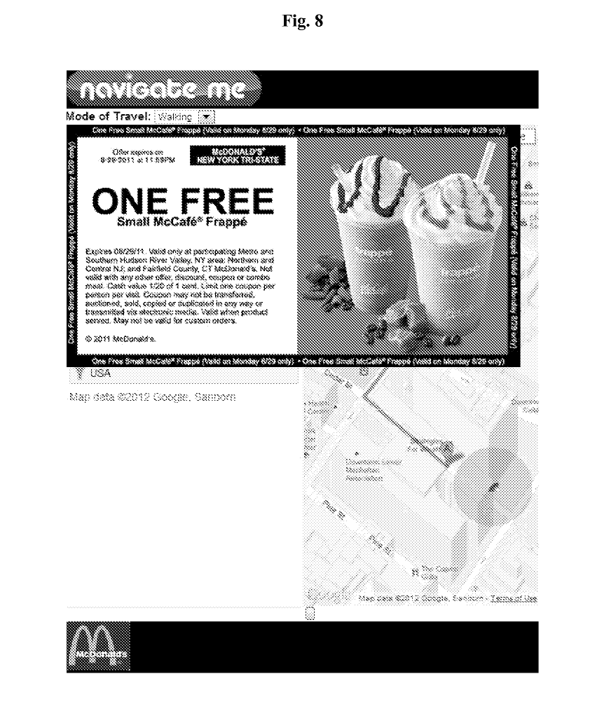

In some embodiments, a proximity-based offer expires if the user leaves area. In further embodiments, a proximity-based offer expires if the user moves more than about 10, 20, 30, 40, 50, 60, 70, 80, 90, 100, 200, 300, 400, 500, 600, 700, 800, 900, or 1000 meters outside of the threshold distance, including increments therein. In other embodiments, a proximity-based offer does not expire based on location. In some embodiments, a proximity-based offer expires after a period of time. In further embodiments, a proximity-based offer expires after about 1, 2, 3, 4, 5, 6, 7, 8, 9, 10, 11, 12, 13, 14, 15, 16, 17, 18, 19, 20, 21, 22, 23, or 24 hours after being triggered, including increments therein. In further embodiments, a proximity-based offer expires after about 1, 2, 3, 4, 5, 6, 7, 8, 9, 10, 11, 12, 13, 14, 15, 16, 17, 18, 19, 20, 21, 22, 23, 24, 25, 26, 27, 28, 29, or 30 days after being triggered, including increments therein. In further embodiments, a proximity-based offer expires after about 1, 2, 3, 4, 5, 6, 7, 8, 9, 10, 11, 12, 13, 14, 15, 16, 17, 18, 19, 20, 21, 22, 23, or 24 months after being triggered, including increments therein. In some embodiments, a proximity-based offer is marked with a date and time of expiration. See, e.g., FIG. 8. In other embodiments, a proximity-based offer does not expire based on the passage of time.

In some embodiments, a proximity-based offer includes one or more requests for information. In further embodiments, a request for information is a request for a user's name, zip code, email address, home address, gender, occupation, or the like. In further embodiments, a request for information is a request for user registration. In still further embodiments, a request for information is a request for a user to subscribe to a service. In some embodiments, a request for information is displayed within the proximity-based offer.

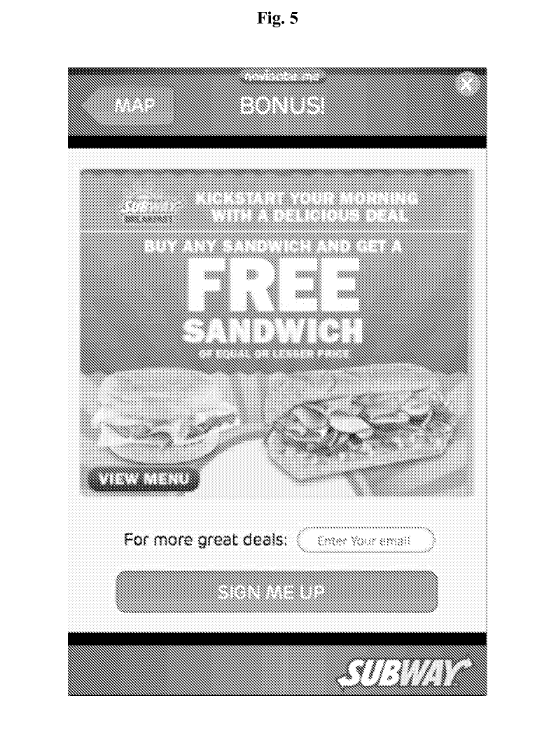

Referring to FIG. 5, in a particular embodiment, a user or a device associated with the user has come within a threshold distance of a selected physical retail outlet offering a food product advertised in an ad unit described herein. In this embodiment, the proximity-based offer is a buy one sandwich, get one sandwich free offer. Further in this embodiment, the proximity-based offer includes a request for the user's email address to subscribe to future offers from the retailer.

Referring to FIG. 8, in a particular embodiment, a user or a device associated with the user has followed the walking directions depicted in FIG. 7 and come within a threshold distance of a selected physical retail outlet offering a food product advertised in an ad unit described herein. In this embodiment, the proximity-based offer is an offer for a free coffee beverage. Further in this embodiment, the proximity-based offer is marked with a specific date and time of expiration.

### User Interactions

In some embodiments, the systems, software, and methods described herein include an ad unit which is expandable in response to a user interaction. In some embodiments, the systems, software, and methods described herein include an ad unit that provides a display of one or more physical retail outlets, directions from the location of the second processing device to a selected physical retail outlet, and/or at least one proximity-based offer in response to a user interaction, or use of the same. Many modes of user interaction, types of user interaction, and input devices are suitable.

In some embodiments, a user interacts with an ad unit, a map of physical retail outlets, directions, and/or a proximity-based offer using a pointing device including, by way of non-limiting examples, a mouse, trackball, trackpad, joystick, pen, or stylus. In further embodiments, a user interacts using a pointing device by actions including, by way of non-limiting examples, hover, click, click and hold, double click, right click, shift-click, control-click, command-click, alt-click, drag, draw, and highlight. In some embodiments, a user interacts with an ad unit, a map of physical retail outlets, directions, and/or a proximity-based offer using a touch screen display or multi-touch screen display. In further embodiments, a user interacts using a touch screen or multi-touch screen by gestures including, by way of non-limiting examples, tap (e.g., touch), double tap, tap and hold, swipe, drag, pinch, reverse pinch, draw, and highlight. In some embodiments, a user interacts with an ad unit, a map of physical retail outlets, directions, and/or a proximity-based offer using a keyboard, keypad, or alternative text input device, by keystroke, combination of keystrokes, or sequence of keystrokes. In other embodiments, a user interacts with an ad unit, a map of physical retail outlets, directions, and/or a proximity-based offer using a microphone to capture voice commands or other sound input. In other embodiments, a user interacts with an ad unit, a map of physical retail outlets, directions, and/or a proximity-based offer using a video camera to capture motion, gestures, or other visual input.

### Data Tracking

In some embodiments, the systems, software, and methods described herein include a software module and one or more databases for collecting, storing, and tracking user, ad unit, offer data, and the like, or use thereof. In some embodiments, the systems, software, and methods described herein track ad data including, by way of non-limiting examples, ad unit impressions served, ad unit clicks, and time spent with the ad unit interacting with the maps, directions, and offers described herein. In some embodiments, the systems, software, and methods described herein track location data including, by way of non-limiting examples, location selected, user starting location, percentage of the total destination reached, and popular routes taken to reach each selected location. In some embodiments, the systems, software, and methods described herein track offer data including, by way of non-limiting examples, number, type, and identity of offers served, number, type, and identity of offers accepted, and number, type, and identity of offers utilized.

### Particular Exemplary Embodiments

In some embodiments, the systems, software, and methods described herein provide an advertisement unit able to drive users into the stores while they are using a publisher app or later via email reminder, or use of the same. The ad unit described herein is optionally implemented with a variety of technologies. In some embodiments, the ad unit comprises an HTML5 code which can run either as standard banner advertisement on every ad network or as in-game reward inside the content provider SDK.

Entry Points

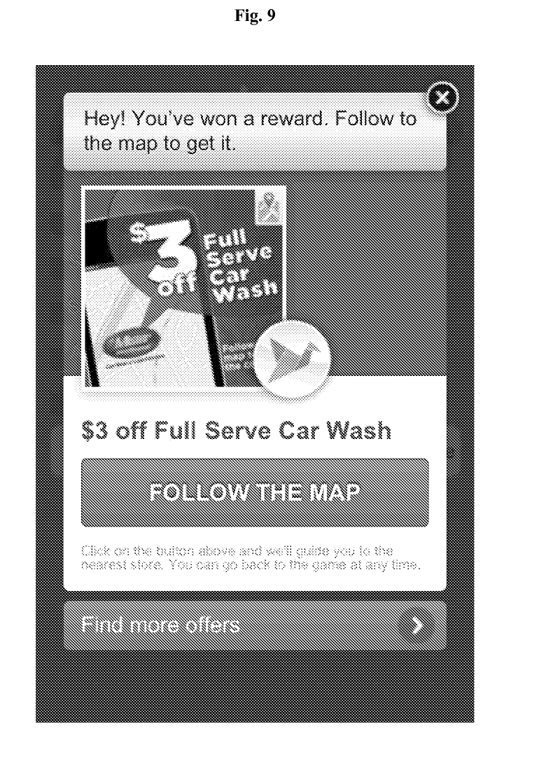

In particular embodiments, there are two different entry points of the unit, either ad-unit banner, or in-game reward. See, e.g., FIG. 9.

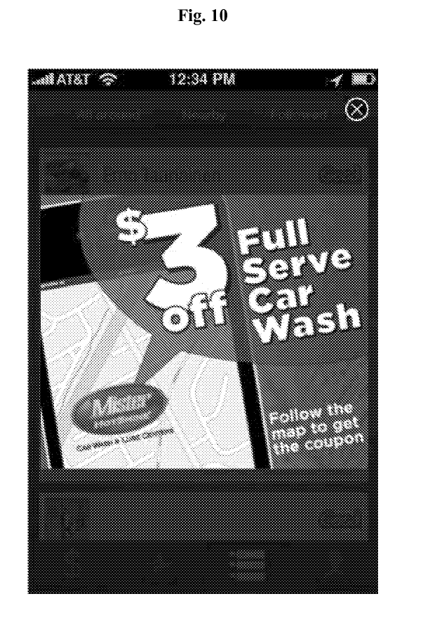

Referring to FIG. 10, in a particular embodiment, the entry point to an ad unit described herein is an in-game reward. In this embodiment, a user playing a native mobile or web-based mobile game is rewarded for game play with presentation of the entry point to the ad unit.

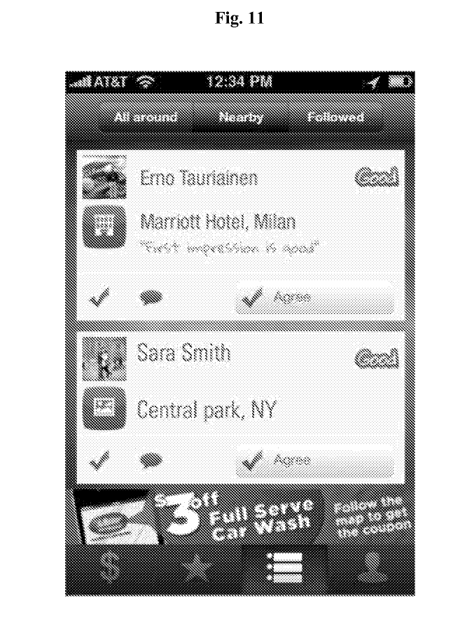

Referring to FIG. 11, in a particular embodiment, the entry point to an ad unit described herein is an ad-unit banner. In this embodiment, a user accessing a native mobile application or a

Deliverable Offers

The systems, software, and methods described herein optionally deliver almost every kind of online/offline offer and gets its best performances with: 1) Gift cards (e.g., “go to Starbucks and get $5 off gift card on your purchases”); 2) Barcode coupons (e.g. ISO/IEC 15416 or ISO/IEC 15426-2); 3) QR code coupons; and 4) Alphanumeric coupons.

Exemplary Ad-Unit Flow

In various embodiments, the process flow follows different paths to optimize the user experience based on the kind of the coupon offered. The following describes a particular exemplary ad-unit flow. Every time the user insert an email in the following flow, the user is subscribed to a content provider, (e.g., Beintoo, etc.) and also receives a registration email if the user is not already registered.

In some embodiments, a user who is using an App receives a standard advertisement banner which can be, for example, 320×50 px, 300×250 px, 320×480 px, 480×320 px or any other customized or standardized ad unit format. In further embodiments, when the user clicks on the banner the user is brought to a web-view landing page which asks the user if they want to go now to the advertized retail outlet, or if at the moment they are busy, they can enter their email address and the user will get the instructions via email. If the user opts to receive an email reminder, the user enters an email address and they are brought to a landing page which is a thank you page saying to follow the instructions sent via email to access the coupon/giftcard. If the user decides to proceed immediately, the ad unit prompts to the user with a geolocation access request which is a system popup respecting the W3C standard. Alternatively, if the user disallows the possibility of geolocation, the user is brought to a page which tells him that he has to activate GSP in order to facilitate provision of directions to the nearest retail outlet and get the coupon.

In some embodiments, if the user allows geolocation, the ad unit shows a map with the shortest path to get to the nearest retail location highlighted. At the bottom of the page there is a button with the possibility of entering an email also at this point. In further embodiments, while the user is following the path a flashing blue dot shows their position and once they get within about 60 meters (about 197 feet) of the store the giftcard/coupon is unlocked. In still further embodiments, a popup is shown to the user with the coupon/giftcard including a disclaimer (if any) and the user can directly scan the barcode or QR code inside the shop (if it is supported by the merchant) or there is a form in order to insert the email and get the coupon via email. At this point the role of the as unit ends and the user can close it going back to the App they were using.

Exemplary SDK Reward Flow

The following describes a particular exemplary SDK Get Reward flow. Every time the user insert an email in the following flow, the user is subscribed to a content provider, (e.g., Beintoo, etc.) and also receives a registration email if the user is not already registered.

In some embodiments, a user who is using an App and unlocks an achievement specified by the developer, gets a reward. In further embodiments, the reward is a special reward discount, which the user obtains (e.g. unlocks, etc.) by going to a nearby retail outlet. In further embodiments, when the user clicks on the reward, they are brought to a web-view landing page which asks them if they want to go now to the store, or if at the moment they are busy, they can enter their email address and they will get the instructions via email. If the user opts to receive an email reminder, the user enters an email address and they are brought to a landing page which is a thank you page saying to follow the instructions sent via email to access the coupon/giftcard. If the user decides to proceed immediately, the ad unit prompts to the user with a geolocation access request which is a system popup respecting the W3C standard. Alternatively, if the user disallows the possibility of geolocation, the user is brought to a page which tells him that he has to activate GSP in order to facilitate provision of directions to the nearest retail outlet and get the coupon.

In some embodiments, if the user allows geolocation, the ad unit shows a map with the shortest path to get to the nearest retail location highlighted. At the bottom of the page there is a button with the possibility of entering an email also at this point. In further embodiments, while the user is following the path a flashing blue dot shows their position and once they get within about 60 meters (about 197 feet) of the store the giftcard/coupon is unlocked. In still further embodiments, a popup is shown to the user with the coupon/giftcard including a disclaimer (if any) and the user can directly scan the barcode or QR code inside the shop (if it is supported by the merchant) or there is a form in order to insert the email and get the coupon via email. At this point the role of the ad unit ends and the user can close it going back to the App.

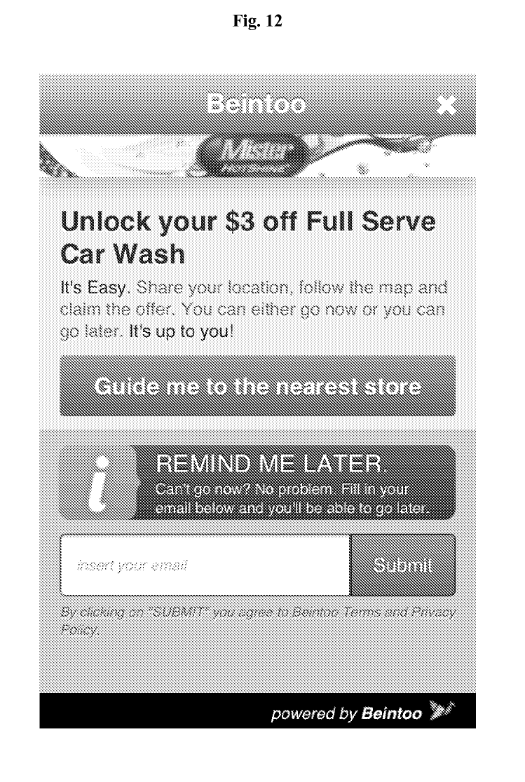

Referring to FIG. 12, in a particular embodiment, upon interacting with the ad unit, whether implemented as an banner ad or an in-game reward, the user is presented with a landing page. In further embodiments, the landing page describes the nature of the offer. In still further embodiments, the landing page allows the user to optionally get directions to navigate to the advertised retailer and activate their offer or to enter an email address to receive instructions, via email, on how to access the offer at a later time.

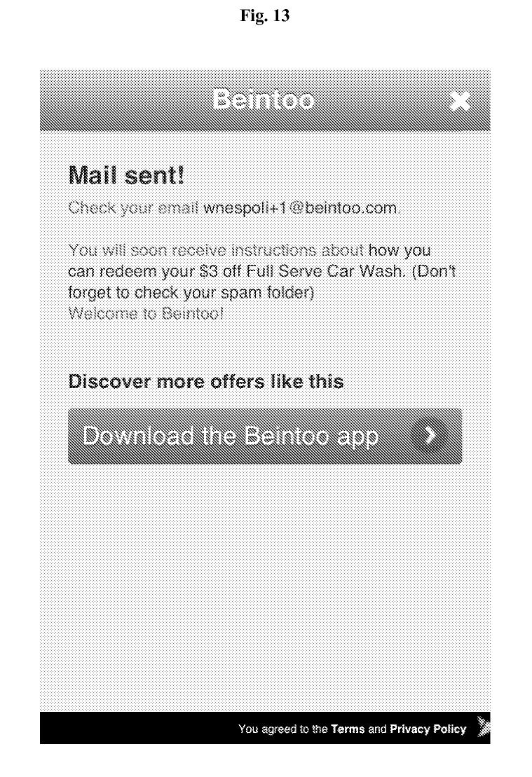

Referring to FIG. 13, in a particular embodiment, a user opting to receive instructions via email, rather than access their offer immediately, is presented with a page confirming that an email was sent. In further embodiments, the sent email confirmation page includes the nature of the offer and the email address to which the instructions were sent.

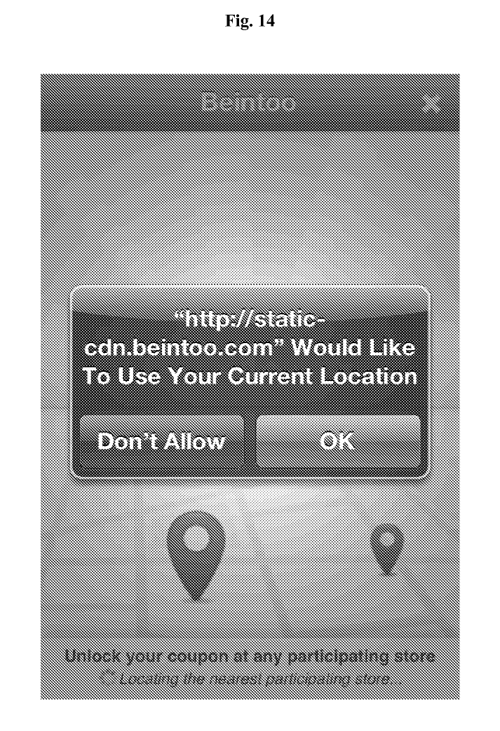

Referring to FIG. 14, in particular embodiments, a user is presented with a geolocation permission dialog prior to any geolocation process.

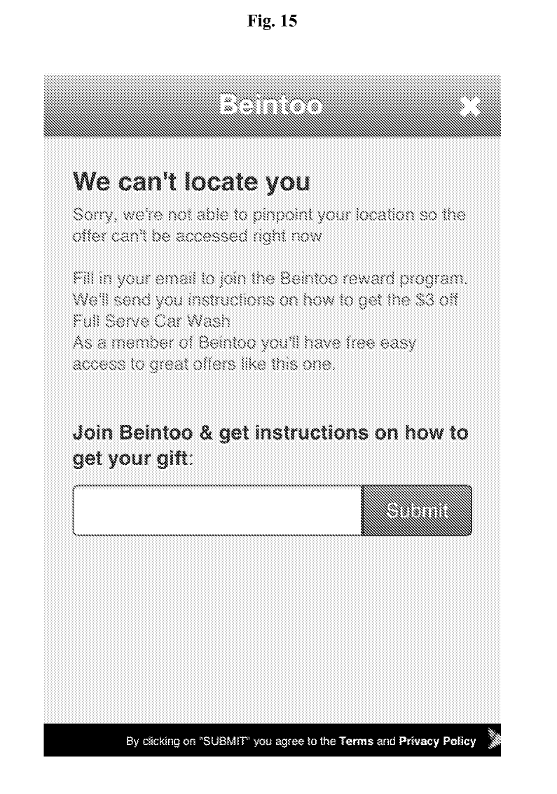

Referring to FIG. 15, in a particular embodiment, where a user indicates that they do not want to be located via their mobile processing device, the user is presented with an instruction page. In further embodiments, the instruction page allows the user to alternatively obtain instructions on accessing their offer via email.

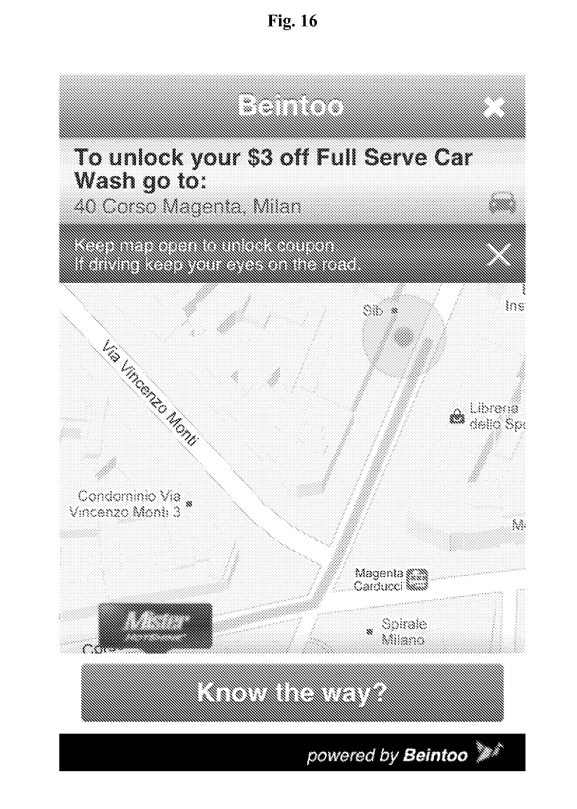

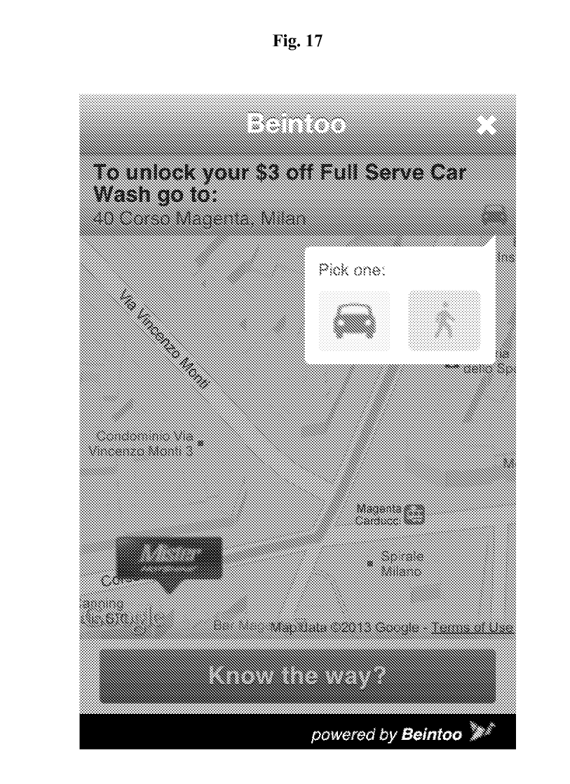

Referring to FIGS. 16 and 17, in a particular embodiment, where a user allows geolocation, the user is presented with a directions page providing directions to one or more physical retail outlets that are nearby (e.g., within a threshold distance). In further embodiments, the directions are in the form of a map with a highlighted pathway. In still further embodiments, the map includes turn-by-turn directions adapted for various forms of travel (e.g., driving, walking, cycling, public transportation, etc.). In some embodiments, the directions page provides voiced audio directions.

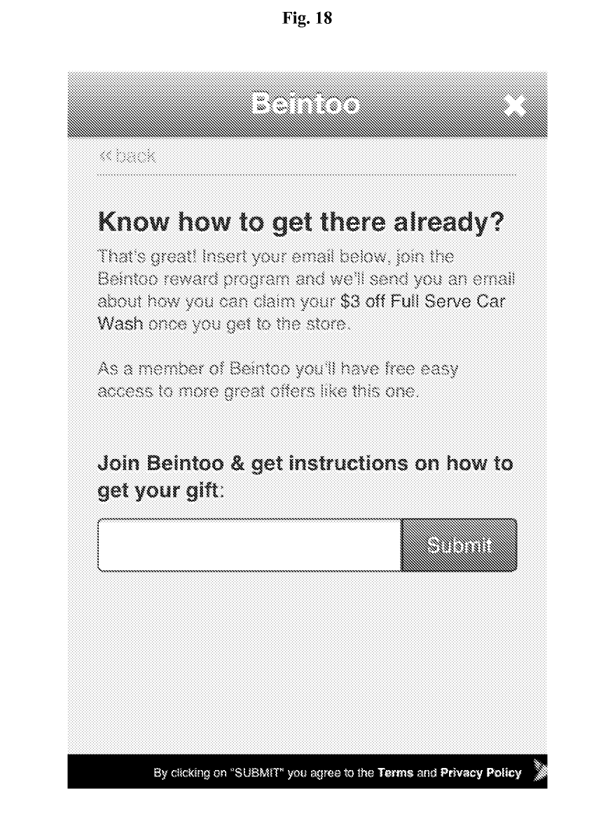

Referring to FIG. 18, in a particular embodiment, where a user indicates that they do not need directions to a particular retail outlet, the user is presented with an opportunity to enter their email address to gain the ability to access their offer at a later time, when they are near the outlet.

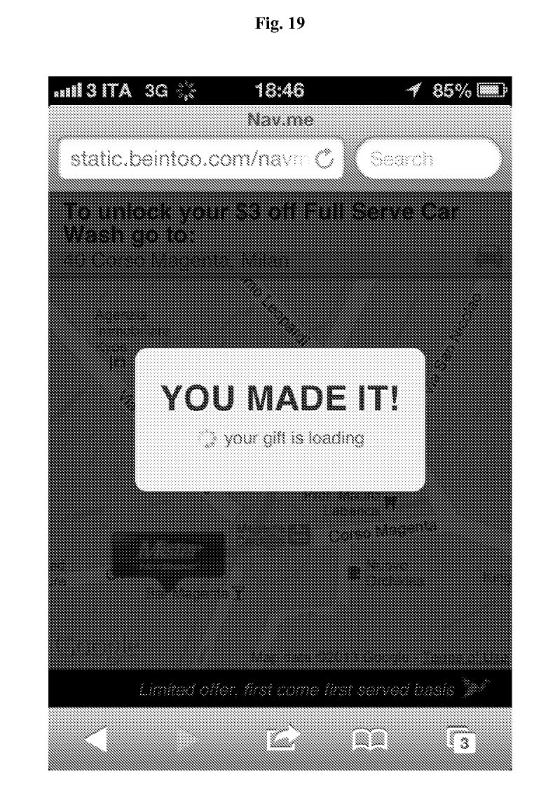

Referring to FIG. 19, in a particular embodiment, a user entering a radius about the retail outlet is presented with an arrival overlay presented over the directions page. In further embodiments, the arrival overlay loads and presents the offer.

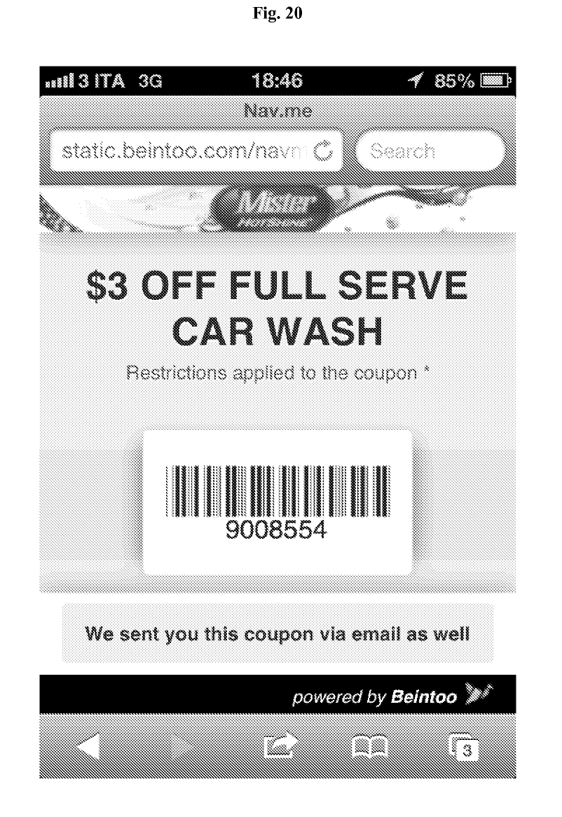

Referring to FIG. 20, in a particular embodiment, a proximity-based offer is presented to a user in the form of a linear barcode coupon. In this embodiment, the coupon is presented within the ad unit and is for a price discount on a service offered by a retail outlet.

Emails

In some embodiments, the user experience described herein is further shaped by emails sent to the user, which help in bringing the user to the retail outlet and/or reminding the user to go there.

By way of example, the user is sent a “go later email.” In such embodiments, a “go later email” is sent when the user indicates, inside the ad unit, to not go to the store and wants to go in another moment. This email includes the description of the coupon and the instructions to get it. Upon clicking on an element of the email, the user is presented with the map and the user can go to the store and get the coupon. If the user opens the email within a 60 meter radius of the store, the ad unit directly presents the coupon because the user is within the threshold distance. Alternatively, if the user clicks from a desktop/laptop/tablet device there is an explanatory page with a video explaining the steps to follow to get the coupon and it says to open the page from a smartphone.

By way of example, the user is sent a “reminder email.” In such embodiments, a “reminder email” is sent about 3 days after the “go later email” if the user has not already gone to the store. The reminder email reminds the user to go to the retail outlet and get the coupon/giftcard. Upon clicking on an element of the email, the user is presented with the map and can go to the store and get the coupon. If the user opens the email within a 60 meter radius of the store, the ad units directly presents the coupon because the user is within the threshold distance. Alternatively, if the user clicks from a desktop/laptop/tablet device there is an explanatory page with a video explaining the steps to follow to get the coupon and it says to open the page from a smartphone.

By way of example, the user is sent a “save for later email.” In such embodiments, a “save for later email” is sent when the user inside the ad unit puts the email in order to get the unlocked coupon in his mailbox. In further embodiments, this email contains the coupon/giftcard codes together with a description of the coupon and where to use it.

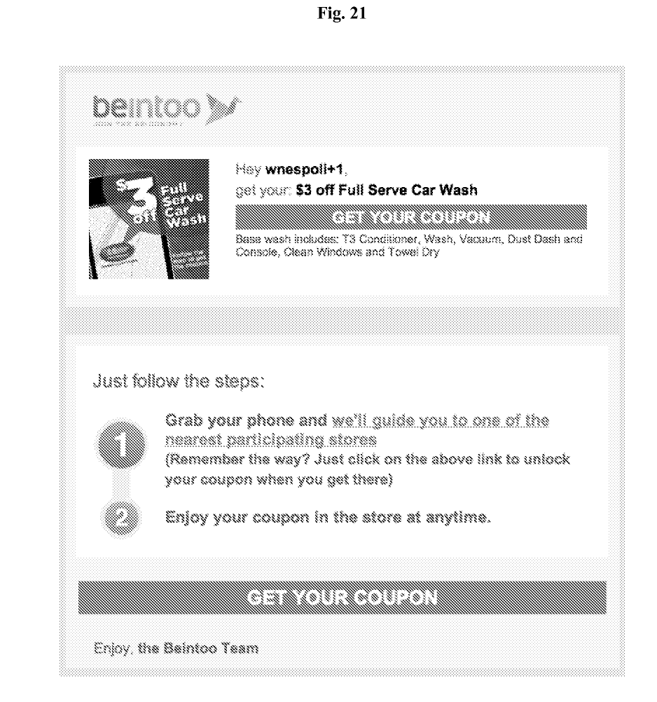

Referring to FIG. 21, in a particular embodiment, a user is sent a “remind me later” email upon indicating that they do not wish to access their offer immediately or indicating that they know the way to the retail outlet and will redeem their offer at a later time when they are nearby.

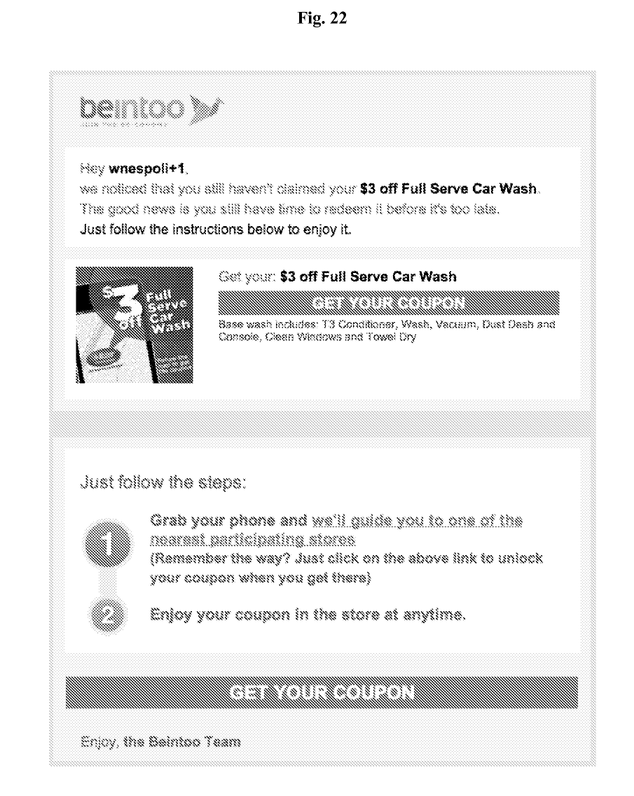

Referring to FIG. 22, in a particular embodiment, when a user does not respond to a “remind me later” email, the user is sent a follow-up after a reasonable amount of time. In a further embodiment, a user is sent a follow-up after about 1 day, 2 days, 3 days, 4 days, 5 days, 6 days, or 1 week, or the like.

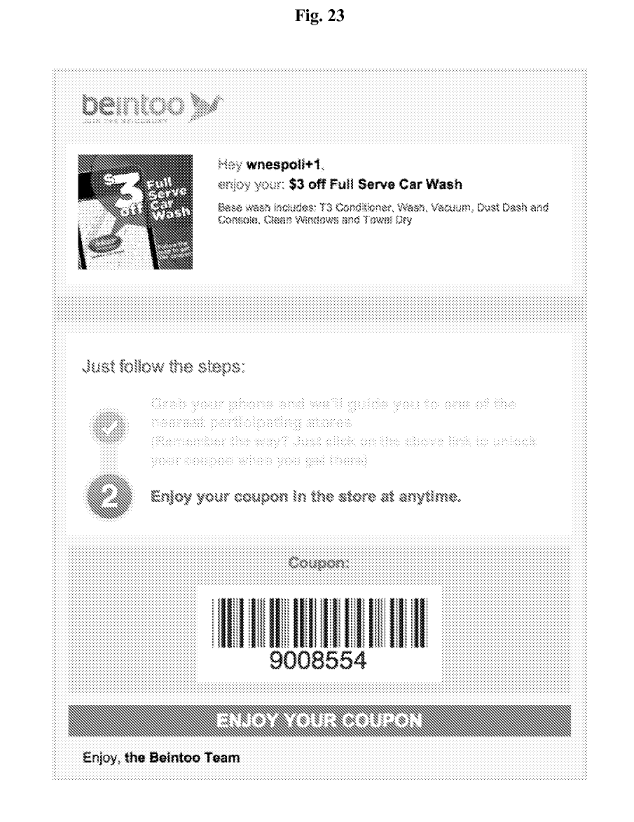

Referring to FIG. 23, in a particular embodiment, a user is sent a proximity-based offer via email. In this embodiment, the offer is for a specific price discount on a service offered by a nearby participating retailer.

Restrictions

In some embodiments, the ad units described herein have some restrictions in order to run properly. For example, in some embodiments, the unit must be able to access the geolocation of the user. In further embodiments, access is granted only by iOS apps while on android it can be run only as mobile web.

Variants

In some embodiments, the ad units described herein are optionally served in one of two variants. First, an “on foot variant,” which is a special configuration targeted only to users who have to reach the stores by foot, so ideal for crowded cities or urban centers. Second, a “by car variant,” which foresees the possibility of switching the navigation by car or by foot. In the by car case, there is a disclaimer about paying attention while driving.

Moreover, in some embodiments, the user experience can be different for registered/non registered users. First, for non registered users, in every step of the process flow there is the possibility of entering an email to get information via email. Second, for registered users, the ad unit does not ask for an email and automatic emails are sent when the user gets the coupon, while the remind me later email is sent only upon user request.

### Digital Processing Device

In some embodiments, the systems, software, and methods described herein include a digital processing device, or use of the same. In further embodiments, the digital processing device includes one or more hardware central processing units (CPU) that carry out the device's functions. In still further embodiments, the digital processing device further comprises an operating system configured to perform executable instructions. In some embodiments, the digital processing device is optionally connected a computer network. In further embodiments, the digital processing device is optionally connected to the Internet such that it accesses the World Wide Web. In still further embodiments, the digital processing device is optionally connected to a cloud computing infrastructure. In other embodiments, the digital processing device is optionally connected to an intranet. In other embodiments, the digital processing device is optionally connected to a data storage device.

In accordance with the description herein, suitable digital processing devices include, by way of non-limiting examples, server computers, desktop computers, laptop computers, notebook computers, sub-notebook computers, netbook computers, netpad computers, set-top computers, handheld computers, Internet appliances, mobile smartphones, tablet computers, personal digital assistants, video game consoles, and vehicles. Those of skill in the art will recognize that many smartphones are suitable for use in the system described herein. Those of skill in the art will also recognize that select televisions, video players, and digital music players with optional computer network connectivity are suitable for use in the system described herein. Suitable tablet computers include those with booklet, slate, and convertible configurations, known to those of skill in the art.

In some embodiments, the digital processing device includes an operating system configured to perform executable instructions. The operating system is, for example, software, including programs and data, which manages the device's hardware and provides services for execution of applications. Those of skill in the art will recognize that suitable server operating systems include, by way of non-limiting examples, FreeBSD, OpenBSD, NetBSD®, Linux, Apple® Mac OS X Server®, Oracle® Solaris®, Windows Server®, and Novell® NetWare®. Those of skill in the art will recognize that suitable personal computer operating systems include, by way of non-limiting examples, Microsoft® Windows®, Apple® Mac OS X®, UNIX®, and UNIX-like operating systems such as GNU/Linux®. In some embodiments, the operating system is provided by cloud computing. Those of skill in the art will also recognize that suitable mobile smart phone operating systems include, by way of non-limiting examples, Nokia® Symbian® OS, Apple® iOS®, Research In Motion® BlackBerry OS°, Google® Android®, Microsoft® Windows Phone® OS, Microsoft® Windows Mobile® OS, Linux®, and Palm® WebOS®.

In some embodiments, the device includes a storage and/or memory device. The storage and/or memory device is one or more physical apparatuses used to store data or programs on a temporary or permanent basis. In some embodiments, the device is volatile memory and requires power to maintain stored information. In some embodiments, the device is non-volatile memory and retains stored information when the digital processing device is not powered. In further embodiments, the non-volatile memory comprises flash memory. In some embodiments, the non-volatile memory comprises dynamic random-access memory (DRAM). In some embodiments, the non-volatile memory comprises ferroelectric random access memory (FRAM). In some embodiments, the non-volatile memory comprises phase-change random access memory (PRAM). In other embodiments, the device is a storage device including, by way of non-limiting examples, CD-ROMs, DVDs, flash memory devices, magnetic disk drives, magnetic tapes drives, optical disk drives, and cloud computing based storage. In further embodiments, the storage and/or memory device is a combination of devices such as those disclosed herein.

In some embodiments, the digital processing device includes a display to send visual information to a user. In some embodiments, the display is a cathode ray tube (CRT). In some embodiments, the display is a liquid crystal display (LCD). In further embodiments, the display is a thin film transistor liquid crystal display (TFT-LCD). In some embodiments, the display is an organic light emitting diode (OLED) display. In various further embodiments, on OLED display is a passive-matrix OLED (PMOLED) or active-matrix OLED (AMOLED) display. In some embodiments, the display is a plasma display. In other embodiments, the display is a video projector. In still further embodiments, the display is a combination of devices such as those disclosed herein.

In some embodiments, the digital processing device includes an input device to receive information from a user. In some embodiments, the input device is a keyboard. In some embodiments, the input device is a pointing device including, by way of non-limiting examples, a mouse, trackball, track pad, joystick, game controller, or stylus. In some embodiments, the input device is a touch screen or a multi-touch screen. In other embodiments, the input device is a microphone to capture voice or other sound input. In other embodiments, the input device is a video camera to capture motion or visual input. In still further embodiments, the input device is a combination of devices such as those disclosed herein.

### Non-Transitory Computer Readable Storage Medium

In some embodiments, the systems, software, and methods disclosed herein include one or more non-transitory computer readable storage media encoded with a program including instructions executable by the operating system of an optionally networked digital processing device. In further embodiments, a computer readable storage medium is a tangible component of a digital processing device. In still further embodiments, a computer readable storage medium is optionally removable from a digital processing device. In some embodiments, a computer readable storage medium includes, by way of non-limiting examples, CD-ROMs, DVDs, flash memory devices, solid state memory, magnetic disk drives, magnetic tape drives, optical disk drives, cloud computing systems and services, and the like. In some cases, the program and instructions are permanently, substantially permanently, semi-permanently, or non-transitorily encoded on the media.

### Computer Program

In some embodiments, the systems, software, and methods disclosed herein include at least one computer program, or use of the same. A computer program includes a sequence of instructions, executable in the digital processing device's CPU, written to perform a specified task. In light of the disclosure provided herein, those of skill in the art will recognize that a computer program may be written in various versions of various languages. In some embodiments, a computer program comprises one sequence of instructions. In some embodiments, a computer program comprises a plurality of sequences of instructions. In some embodiments, a computer program is provided from one location. In other embodiments, a computer program is provided from a plurality of locations. In various embodiments, a computer program includes one or more software modules. In various embodiments, a computer program includes, in part or in whole, one or more web applications, one or more mobile applications, one or more standalone applications, one or more web browser plug-ins, extensions, add-ins, or add-ons, or combinations thereof.

### Web Application

In some embodiments, a computer program includes a web application. In light of the disclosure provided herein, those of skill in the art will recognize that a web application, in various embodiments, utilizes one or more software frameworks and one or more database systems. In some embodiments, a web application is created upon a software framework such as Microsoft® .NET or Ruby on Rails (RoR). In some embodiments, a web application utilizes one or more database systems including, by way of non-limiting examples, relational, non-relational, object oriented, associative, and XML database systems. In further embodiments, suitable relational database systems include, by way of non-limiting examples, Microsoft® SQL Server, mySQL™, and Oracle®. Those of skill in the art will also recognize that a web application, in various embodiments, is written in one or more versions of one or more languages. A web application may be written in one or more markup languages, presentation definition languages, client-side scripting languages, server-side coding languages, database query languages, or combinations thereof. In some embodiments, a web application is written to some extent in a markup language such as Hypertext Markup Language (HTML), Extensible Hypertext Markup Language (XHTML), or eXtensible Markup Language (XML). In some embodiments, a web application is written to some extent in a presentation definition language such as Cascading Style Sheets (CSS). In some embodiments, a web application is written to some extent in a client-side scripting language such as Asynchronous Javascript and XML (AJAX), Flash® Actionscript, Javascript, or Silverlight®. In some embodiments, a web application is written to some extent in a server-side coding language such as Active Server Pages (ASP), ColdFusion®, Perl, Java™, JavaServer Pages (JSP), Hypertext Preprocessor (PHP), Python™, Ruby, Tcl, Smalltalk, WebDNA®, or Groovy. In some embodiments, a web application is written to some extent in a database query language such as Structured Query Language (SQL). In some embodiments, a web application integrates enterprise server products such as IBM® Lotus Domino®. In some embodiments, a web application includes a media player element. In various further embodiments, a media player element utilizes one or more of many suitable multimedia technologies including, by way of non-limiting examples, Adobe® Flash®, HTML 5, Apple® QuickTime®, Microsoft® Silverlight®, Java™, and Unity®.

### Mobile Application

In some embodiments, a computer program includes a mobile application provided to a mobile digital processing device. In some embodiments, the mobile application is provided to a mobile digital processing device at the time it is manufactured. In other embodiments, the mobile application is provided to a mobile digital processing device via the computer network described herein.

In view of the disclosure provided herein, a mobile application is created by techniques known to those of skill in the art using hardware, languages, and development environments known to the art. Those of skill in the art will recognize that mobile applications are written in several languages. Suitable programming languages include, by way of non-limiting examples, C, C++, C#, Objective-C, Java™, Javascript, Pascal, Object Pascal, Python™, Ruby, VB.NET, WML, and XHTML/HTML with or without CSS, or combinations thereof.

Suitable mobile application development environments are available from several sources. Commercially available development environments include, by way of non-limiting examples, AirplaySDK, alcheMo, Appcelerator®, Celsius, Bedrock, Flash Lite, .NET Compact Framework, Rhomobile, and WorkLight Mobile Platform. Other development environments are available without cost including, by way of non-limiting examples, Lazarus, MobiFlex, MoSync, and Phonegap. Also, mobile device manufacturers distribute software developer kits including, by way of non-limiting examples, iPhone and iPad (iOS) SDK, Android™ SDK, BlackBerry® SDK, BREW SDK, Palm® OS SDK, Symbian SDK, webOS SDK, and Windows® Mobile SDK.

Those of skill in the art will recognize that several commercial forums are available for distribution of mobile applications including, by way of non-limiting examples, Apple® App Store, Android™ Market, BlackBerry® App World, App Store for Palm devices, App Catalog for webOS, Windows® Marketplace for Mobile, Ovi Store for Nokia® devices, Samsung® Apps, and Nintendo® DSi Shop.

### Software Modules

The systems, software, and methods disclosed herein include, in various embodiments, software, server, and database modules, or use of the same. In view of the disclosure provided herein, software modules are created by techniques known to those of skill in the art using machines, software, and languages known to the art. The software modules disclosed herein are implemented in a multitude of ways. In various embodiments, a software module comprises a file, a section of code, a programming object, a programming structure, or combinations thereof. In further various embodiments, a software module comprises a plurality of files, a plurality of sections of code, a plurality of programming objects, a plurality of programming structures, or combinations thereof. In various embodiments, the one or more software modules comprise, by way of non-limiting examples, a web application, a mobile application, and a standalone application. In some embodiments, software modules are in one computer program or application. In other embodiments, software modules are in more than one computer program or application. In some embodiments, software modules are hosted on one machine. In other embodiments, software modules are hosted on more than one machine. In further embodiments, software modules are hosted on cloud computing platforms. In some embodiments, software modules are hosted on one or more machines in one location. In other embodiments, software modules are hosted on one or more machines in more than one location.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention.

What is claimed is:

1. A computer-implemented system comprising a first processing device configured to generate and deliver an ad unit for at least one good or service offered at a physical retail outlet, the ad unit delivered to an application executing on a second processing device, the ad unit providing, in response to a user interaction:
a. a display of one or more physical retail outlets, the outlets offering the at least one good or service, the outlets located within a first threshold distance from the second processing device;
b. directions from the location of the second processing device to a selected physical retail outlet; and
c. at least one proximity-based offer, the offer triggered by presence of the second processing device within a second threshold distance from the selected physical retail outlet;
provided that the display of one or more physical retail outlets, the directions, and the at least one proximity based-offer are provided within the application executing on the second processing device.

2. The system of claim 1, wherein the second processing device is a mobile device.

3. The system of claim 2, wherein the application executing on the second processing device is a mobile web browser or a native mobile application.

4. The system of claim 1, wherein the first threshold distance is less than about 10 miles, less than about 5 miles, less than about 2 miles, or less than about 1 mile.

5. The system of claim 4, wherein the first threshold distance is less than about 1000 meters, less than about 500 meters, less than about 200 meters, or less than about 100 meters.

6. The system of claim 1, wherein the second threshold distance is less than about 5 miles, less than about 2 miles, less than about 1 mile, or less than about 0.5 mile.

7. The system of claim 6, wherein the second threshold distance is less than about 500 meters, less than about 200 meters, less than about 100 meters, or less than about 50 meters.

8. The system of claim 1, wherein the directions are walking directions, cycling directions, driving directions, or mass transit directions.

9. The system of claim 1, wherein the offer comprises a discount, coupon, or voucher.

10. The system of claim 1, wherein the ad unit is an expanding banner ad, an interstitial ad, a three-dimensional multimedia ad, or a combination thereof.

11. The system of claim 1, wherein the proximity-based offer does not require user check-in.

12. The system of claim 1, wherein the ad unit does not open a browser window and does not open a mobile application.

13. A computer-implemented method comprising the steps of:
a. generating, by a first processing device, an ad unit for at least one good or service offered at a physical retail outlet; and
b. delivering, by the first processing device, the ad unit to an application executing on a second processing device, the ad unit providing:
i. a display of one or more physical retail outlets, the outlets offering the at least one good or service, the outlets located within a first threshold distance from the second processing device;
ii. directions from the location of the second processing device to a selected physical retail outlet; and
iii. at least one proximity-based offer, the offer triggered by presence of the second processing device within a second threshold distance from the selected physical retail outlet;
with the proviso that that the display of one or more physical retail outlets, the directions, and the at least one proximity based-offer are provided within the application executing on the second processing device.

14. The method of claim 13, wherein the second processing device is a mobile device and the application executing on the second processing device is a mobile web browser or a native mobile application.

15. The method of claim 13, wherein the first threshold distance is less than about 10 miles, less than about 5 miles, less than about 2 miles, less than about 1 mile, or less than about 0.5 miles.

16. The method of claim 13, wherein the second threshold distance is less than about 5 miles, less than about 2 miles, less than about 1 mile, less than about 0.5 mile, less than about 0.25 mile, or less than about 0.1 mile.

17. The method of claim 13, wherein the directions are walking directions, cycling directions, driving directions, or mass transit directions.

18. The method of claim 13, wherein the offer comprises a discount, coupon, or voucher.

19. The method of claim 13, wherein the ad unit is an expanding banner ad, an interstitial ad, a three-dimensional multimedia ad, or a combination thereof.

20. The method of claim 13, wherein the proximity-based offer does not require user check-in.

21. The method of claim 13, wherein the ad unit does not open a browser window and does not open a mobile application.

22. Non-transitory computer-readable storage media encoded with a computer program including instructions executable by a processor to create and deliver a mobile ad unit comprising:
a. a software module configured to determine the location of a mobile user;
b. a software module configured to display of one or more physical retail outlets, the outlets offering at least one good or service, the outlets located within a first threshold distance from the user;
c. a software module configured to provide directions from the location of the user to a selected physical retail outlet; and
d. a software module configured to provide at least one proximity-based offer, the offer triggered by presence of the user within a second threshold distance from the selected physical retail outlet;
provided that the display of one or more physical retail outlets, the directions, and the at least one proximity based-offer are fully contained within the ad unit.

23. The media of claim 22, wherein the ad unit is delivered to a mobile web browser or a native mobile application.

24. The media of claim 22, wherein the ad unit is an expanding banner ad, an interstitial ad, a three-dimensional multimedia ad, or a combination thereof.

25. The media of claim 22, wherein the first threshold distance is less than about 10000 meters, less than about 5000 meters, less than about 1000 meters, less than about 500 meters, less than about 200 meters, or less than about 100 meters.

26. The media of claim 22, wherein the second threshold distance is less than about 5000 meters, less than about 500 meters, less than about 200 meters, less than about 100 meters, or less than about 50 meters.

27. The media of claim 22, wherein the directions are walking directions, cycling directions, driving directions, or mass transit directions.

28. The media of claim 22, wherein the offer comprises a discount, coupon, or voucher.

29. The media of claim 22, wherein the proximity-based offer does not require user check-in.

30. The media of claim 22, wherein the ad unit does not open a browser window and does not open a mobile application.
